(19) United States
(12) Patent Application Publication
(10) Pub. No.: US 2012/0116990 A1
(43) Pub. Date: May 10, 2012

(54) SYSTEM AND METHOD FOR ALLOCATING ASSETS AMONG FINANCIAL PRODUCTS IN AN INVESTOR PORTFOLIO

(75) Inventor: Dylan W. Huang, New York, NY (US)

(73) Assignee: NEW YORK LIFE INSURANCE COMPANY, New York, NY (US)

(21) Appl. No.: 12/939,929

(22) Filed: Nov. 4, 2010

(51) Int. Cl. G06Q 40/00

(52) U.S. Cl. 705/36 R

(57) ABSTRACT

A computerized method and system for allocating assets among a plurality of financial products for an investor portfolio includes calculating a solution space of financial vehicle combinations by assigning allocations to each financial vehicle in each financial vehicle combination and generating a set of simulations, for each of the vehicle combinations, of a value of the financial vehicle combination. The computerized method and system further includes receiving investor-specific information, the investor-specific information including a retirement objective. The method and system further includes selecting a set of financial vehicle combinations within the solution space based on the received investor-specific information; and allocating assets among the plurality of financial products based on the set of selected financial vehicle combinations and received investor-specific information.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates to the field of computerized methods and systems for financial planning, and more particularly, to computerized methods and systems for providing investment or retirement portfolio allocations among a plurality of financial investment vehicles.

### BACKGROUND OF THE INVENTION

People planning for retirement need to consider several risks. One is longevity risk, which is the risk of living longer than expected and potentially out living assets. Another is withdrawal risk, which is the risk that the retiree's rate of savings withdrawal is unsustainable and will completely deplete the savings before death. The third is inflation risk, where the purchasing power of the assets is reduced due to inflation. Finally, there is also the sequence of returns risk, which is the risk of poor market performance in the early years of retirement. Collectively, these risks could impact retirement outcome. Fortunately, a variety of investment vehicles exist in order to mitigate these risks.

One investment vehicle that some may use in retirement is common stock, which has the potential to produce high returns. Unfortunately, these returns can also be volatile, and losses due to stock volatility may severely impact retirement savings. Alternatively, investments in cash equivalents are far less volatile, but yields may be unacceptably low. An asset allocation made up of stocks, bonds, real estate, cash equivalents and other asset classes may therefore be desirable for some investors to minimize volatility while maintaining acceptable returns. Model portfolios may be created by research departments of financial institutions to achieve a desired return for a given risk tolerance. Model portfolios are mostly created based on a risk return profile. For example, a conservative portfolio might include 65% bonds and 35% equities, and an aggressive portfolio might include 20% bonds and 80% equities. One who is skilled in the art will understand and appreciate that allocations of the portfolios can be changed based on various market forces and/or customer desires.

Another type of asset that can be purchased for retirement is an annuity. Annuities are available in many forms, e.g., deferred variable annuities, deferred fixed annuities, deferred income annuities, variable immediate annuities and fixed immediate annuities. A fixed immediate annuity is a well-known financial vehicle offered by insurance companies that is used to pay a person a certain sum of money in a series of distributions made at regular intervals, typically monthly or annually starting at a given date, based on a given amount of principal from an initial contribution of assets, commonly known as premium. Income annuities are available in many forms. The distributions may be made for a predetermined definite period, as in an annuity certain, or for as long as the person lives, as in a life annuity. Payments under a life annuity may terminate on the annuitant's death, as in a straight life annuity, or may continue to a beneficiary for a specified period after the annuitant's death, as in a life annuity with period certain. Alternatively, a life annuity may be based on two lives jointly, as in a joint and last-survivor annuity in which payments continue to be made to the survivor for the remainder of his or her life. The payments under an income annuity may be set to begin one payment interval after purchase of the annuity, as in an immediate income annuity, or after a specified amount of time, as in a deferred income annuity.

It is difficult, however, for retirees to determine what mix of asset classes, and in what proportion, will produce desired retirement objectives. In addition, investors may also have competing desires for their retirement assets. One such desire could be the legacy potential of the assets, which is the ability to leave assets to heirs, after the retiree's death. Another such desire is liquidity potential, including the ability to withdraw as cash or to convert to cash all or a large portion of the assets on relatively short notice, such as in the event of a medical emergency. Therefore, it can be important that the assets not be locked up in a financial vehicle that makes them inaccessible or illiquid. Simply using traditional assets via model portfolios may not adequately address all retirement risks, and the problem becomes even more difficult should the investor desire to allocate retirement assets among not only traditional assets, but also non-traditional assets, such as annuities.

Traditional asset allocations are constructed based on the modern portfolio theory (“MPT”) developed by Harry Markowitz and William Sharpe. See Markowitz, Harry “Portfolio Selection,” Journal of Finance, September 1952, pp. 77-91; and Sharpe, William “Capital Asset Prices: A Theory of Market Equilibrium,” Journal of Finance, September 1964. MPT selects optimal portfolio allocations based on the investor's risk tolerance. Essentially, it is a mean-variance optimization. MPT is widely accepted in the academic and the finance industry as the primary tool for developing asset allocations. However, because MPT expresses an investor's preference between risk and expected return, it lacks consideration of retirement risk factors.

Consideration of an investor's desire outside of risk tolerance and expected return are not adequately addressed in existing portfolio allocation offerings. Present systems operate according to the MPT, and allocate assets among investments based on the investor's risk tolerance. Unfortunately, these systems do not consider retirement risks, such as likelihood of running out of money, legacy and/or liquidity desires. Therefore, there exists a need for an improved investment portfolio allocation system and method.

### SUMMARY OF THE INVENTION

The present invention overcomes the above-noted and other shortcomings of the prior art by providing novel and improved computerized methods and systems for allocating assets among a plurality of financial products for an investor portfolio.

Generally, a computerized method according to embodiments of the present invention for allocating assets among a plurality of financial products for an investor portfolio includes calculating a solution space of financial vehicle combinations by assigning allocations to each financial vehicle in each financial vehicle combination and generating a set of simulations, for each of the vehicle combinations, of a value of the financial vehicle combination. In some embodiments, calculating a solution space of financial vehicles can include, for example, calculating a solution space of financial vehicles selected from the set consisting of: model portfolios, fixed immediate annuities, and deferred variable annuities with guaranteed lifetime withdrawal benefits. According to additional embodiments, generating a set of simulations includes generating a set of Monte Carlo simulations.

The method and system further includes receiving investor-specific information, the investor-specific information including a retirement objective. Additional investor-specific information, in some embodiments, includes at least one of: marital status, gender, age, subjective life expectancy, an investment amount, and a desired withdrawal rate. Also in some embodiments, the retirement objective includes an investor(s)' preference between income security, liquidity potential, and legacy potential.

The method and system further includes selecting a set of financial vehicle combinations within the solution space based on the received investor-specific information, and allocating assets among the plurality of financial products based on the set of selected financial vehicle combinations and received investor-specific information. In some embodiments, selecting a set of financial vehicle combinations further includes eliminating financial vehicle combinations within the selected set of financial vehicle combinations based on a reward-to-risk ratio. The reward-to-risk ratio, in some embodiments, is based on a statistical measurement (e.g., average, 50^{th} percentile, etc.) of the legacy value at a subjective life expectancy and a probability of ruin (i.e., the probability of running out of assets) at a time horizon beyond the life expectancy. Depending on liquidity needs, the reward-to-risk ratio can also be based on a statistical measure of the liquid asset value prior to the subjective life expectancy. In additional embodiments, the step of selecting a set of financial vehicle combinations within the solution space further includes generating frontier lines, based on the selected set of financial vehicle combinations and partitioning the frontier representation based on the number of retirement objectives available to the investor(s). In some embodiments, the step of partitioning the frontier representation follows by the selection of a financial vehicle combination within each of the partitions of the frontier representation, the financial vehicle combination based on a reward-to-risk ratio, and providing, as a recommendation to the investor(s), the selected financial vehicle combinations based on the retirement objective. The computerized method and system may also re-optimize the allocation of assets and products among the plurality of financial products, with re-optimization further comprising selecting a financial vehicle combination by searching a solution space based on the received investor-specific information; and re-allocating the original asset and product allocations by assigning allocations to each financial product based on the selected financial vehicle combination.

Some or all of the above and other deficiencies in the prior art are further resolved by a computer program product for use in a computer system that executes program steps recorded on one or more computer readable media to perform a method for providing an allocation of assets among a plurality of financial products for an investor portfolio, the computer program product including one or more computer readable media and one or more computer programs of computer readable instructions executable by the computer system to perform method steps.

The method steps may further include calculating a solution space of financial vehicle combinations by assigning allocations to each financial vehicle in each financial vehicle combination and generating a simulation, for each of the vehicle combinations, of a value of the financial vehicle combination. In some embodiments, calculating a solution space of financial vehicles further includes calculating a solution space of financial vehicles selected from the set consisting of: model portfolios, fixed immediate annuities, and deferred variable annuities with guaranteed lifetime withdrawal benefits. In some embodiments, generating a set of simulations further includes generating a set of Monte Carlo simulations.

The method steps may further include receiving investor-specific information, the investor-specific information including a retirement objective.

The method steps may further include selecting a set of financial vehicle combinations within the solution space based on the received investor-specific information, as well as including allocating assets based on the set of selected financial vehicle combinations and received investor-specific information. In some embodiments, selecting a set of financial vehicle combinations further includes eliminating financial vehicle combinations within the selected set of financial vehicle combinations based on a reward-to-risk ratio. While in further embodiments, the reward-to-risk ratio is based on a statistical measurement (e.g., average, 50^{th} percentile, etc.) of the legacy value at a life expectancy and a probability of ruin after the life expectancy. In some embodiments, the financial vehicle combinations within the solution space further includes generating a frontier representation based on the selected set of financial vehicle combinations, and further embodiments include partitioning the frontier representation based on the retirement objectives. The step of partitioning the frontier representation may also further include selecting a financial vehicle combination within each of the partitions of the frontier representation, the financial vehicle combination based on a reward-to-risk ratio, with further embodiments including providing, as a recommendation to the investor, the selected financial vehicle combination.

Some embodiments include the step of re-optimizing an allocation of assets and products among the plurality of financial products.

Some or all of the above and other deficiencies in the prior art are further resolved by a computerized system for providing an allocation of assets among a plurality of financial products for an investor portfolio. The system may further include means for calculating a solution space of financial vehicle combinations by assigning allocations to each financial vehicle in each financial vehicle combination and generating a set of simulations, for each of the vehicle combinations, of a value of the financial vehicle combination. The system may further include means for receiving investor-specific information, the investor-specific information including a retirement objective. The system may further include means for selecting a set of financial vehicle combinations within the solution space based on the received investor-specific information. Finally, the system may also include means for allocating assets among the plurality of financial products based on the set of selected financial vehicle combinations and received investor-specific information.

Some or all of the above and other deficiencies in the prior art are further resolved by a computerized method for re-optimizing an allocation of assets and products among a plurality of investment products for an investor portfolio, comprising receiving an original asset and product allocation for the investor portfolio, receiving investor-specific information, selecting a financial vehicle combination by searching a solution space based on the received investor-specific information; and re-allocating the original asset and product allocation for the investor portfolio by assigning allocations to each financial product based on the selected financial vehicle combination, wherein re-allocating further comprises distinguishing between a liquid and a non-liquid financial product in the original asset and product allocation for the investor portfolio, and adjusting the liquid financial product based on the selected financial vehicle combination.

### BRIEF DESCRIPTION OF THE DRAWINGS

FIG. 1 illustrates a flowchart of the steps of one embodiment of a method for allocation of assets and products;

FIGS. 2 through 4 present embodiments for creating a solution space to facilitate a method for allocation of assets and products;

FIG. 5 illustrates a flow chart of the steps of one embodiment for surveying an investor to facilitate a method for allocation of assets and products;

FIGS. 6 through 10 present embodiments for searching a solution space and presenting recommendations to facilitate a method for allocation of assets and products;

FIG. 11 illustrates a flowchart of the steps for one embodiment for allocation of assets and products;

FIG. 12 illustrates a processing system operative to provide an allocation of assets and products; and

FIGS. 13 and 14 present embodiments for re-optimizing an allocation of assets and products.

### DETAILED DESCRIPTION OF THE EMBODIMENTS

In the following description, reference is made to the accompanying drawings that form a part hereof, and in which is shown by way of illustration of specific embodiments in which the invention may be practiced. It is to be understood that other embodiments may be utilized and structural changes may be made without departing from the scope of the present invention.

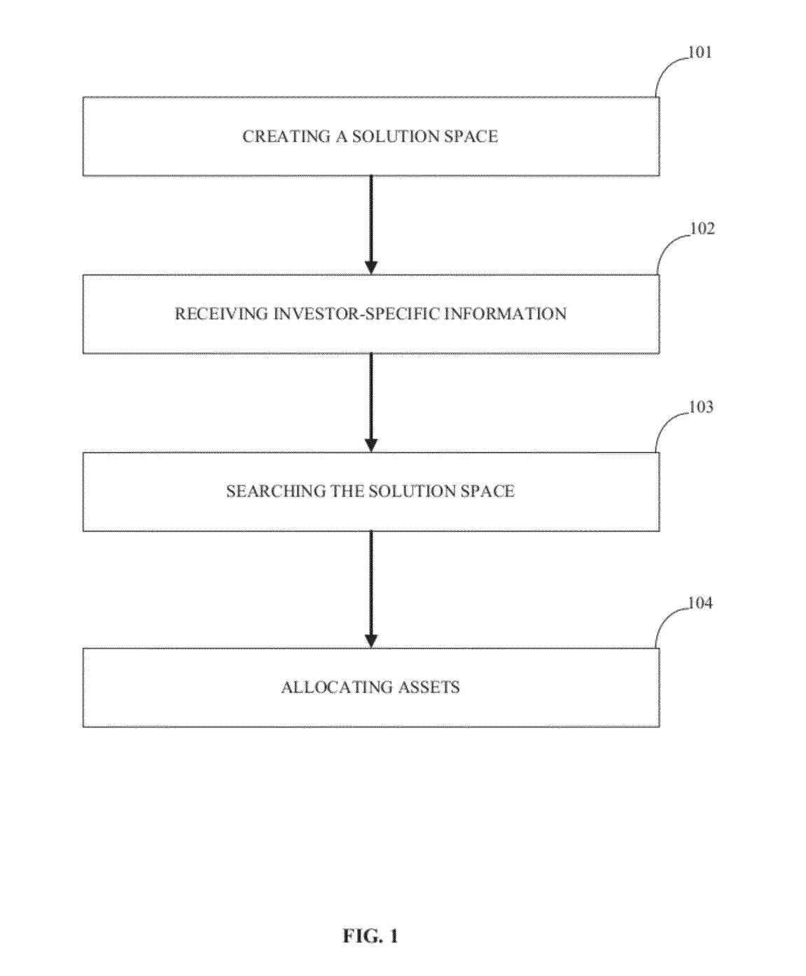

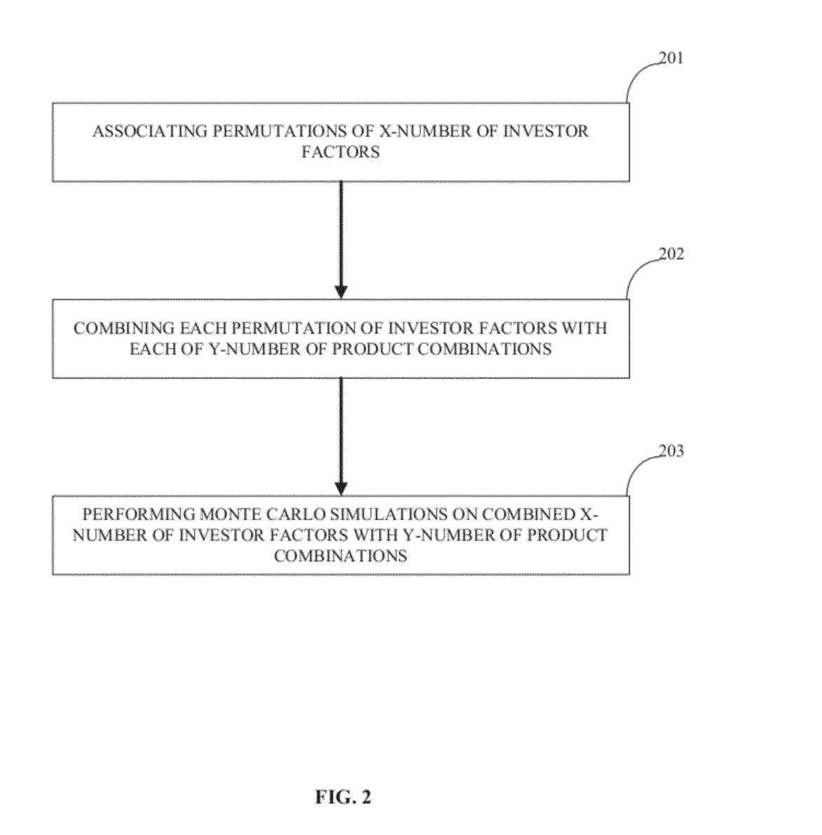

FIG. 1 illustrates a flow chart of one embodiment of a computerized method for providing an allocation of assets among a plurality of financial products for an investor portfolio. The flowchart represents a generalized description of one embodiment, wherein FIGS. 2-4 and the discussion below provide further aspects of the embodiment of FIG. 1 and additional embodiments thereto. To recommend the optimal allocation between a plurality of investment vehicles (also known as products), as shown in the embodiment in FIG. 1, four steps are performed: (1) creating a solution space 101; (2) receiving investor-specific information 102; (3) searching the solution space; and (4) allocating assets and products 103. Additionally, a fifth step (not shown), re-optimization of the asset and product portfolio, may be performed.

Accomplishment of these goals is obtained by analyzing and combining model portfolios, deferred variable annuities inclusive of all commonly selected riders (e.g., guaranteed minimum accumulation benefit, guaranteed lifetime withdrawal benefit, guaranteed minimum withdrawal benefit, guaranteed minimum death benefit, guaranteed minimum income benefit), deferred fixed annuities, deferred income annuities, variable immediate annuities and fixed immediate annuities inclusive of all commonly selected options/riders (e.g., inflation protection options such as cost of living adjustments and CPI-indexed payouts). An optimal allocation of these assets and products based on maximizing potential legacy and/or liquidity needs from the investments, while minimizing the probability of running out of money during the investor(s)' lifetime are recommended. One skilled in the art will understand that additional or different types of products or assets may be added or substituted for the specific products and assets discussed in the described embodiments.

In this embodiment, the computerized method begins, step 101, by creating a solution space.

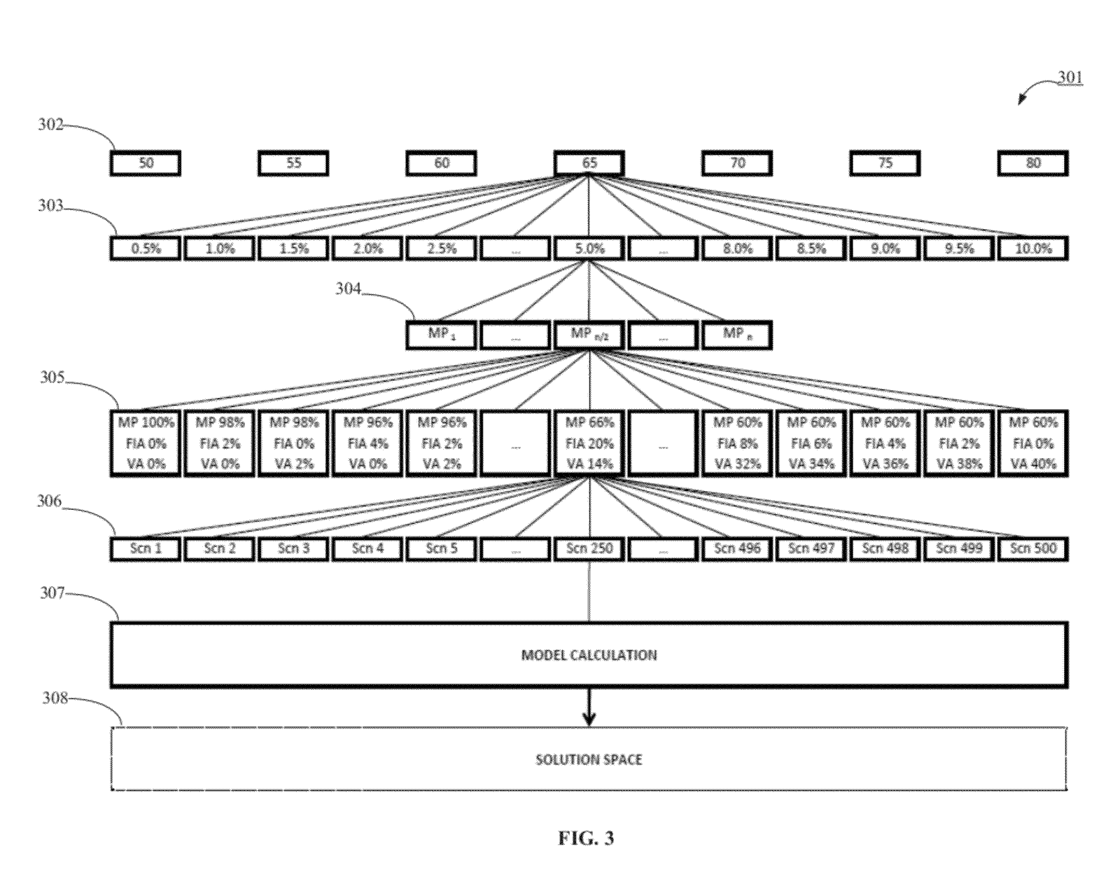

FIG. 2 illustrates a flow chart of an embodiment for creating the solution space. In this embodiment, the computerized method begins, step 201, by associating permutations of investor factors. As shown by the example in FIG. 3, these investor factors can include age(s) 302 and a desired withdrawal rate or income need 303. The desired withdrawal rate is applied to the initial investment amount. The withdrawal amount would then increase with inflation. In the example shown by FIG. 3, to reduce the number of calculations to create the solution space, in this embodiment investor ages are grouped into seven five-year periods ranging from age 50 to age 85 (e.g., 50-54, 55-59, etc.). As explained below, an increase in the number of ages or age groups increases the number of calculations to create the solution space. The number and types of investor factors may be increased, decreased, or varied.

Referring back to FIG. 2, after the permutations of investor factors are associated in 201, the method proceeds to step 202. In step 202 each permutation from step 201 is combined with each asset and product combination, including model portfolios 304. An example of which is shown by the embodiment of FIG. 3, element 305. In element 305, the different types of assets and products are model portfolios, fixed immediate annuities, and deferred variable annuities with guaranteed lifetime withdrawal benefit. However, additional products may be used or substituted for those products, such as, deferred variable annuities with other commonly selected riders (e.g., guaranteed minimum accumulation benefit, guaranteed minimum withdrawal benefit, guaranteed minimum death benefit, guaranteed minimum income benefit), deferred fixed annuities, deferred income annuities and variable immediate annuities. The product availability included in the solution space will be specified by the financial intermediary, such as a financial advisory services firm. For example, one financial intermediary might choose to only include deferred variable annuities with guaranteed lifetime withdrawal benefit and fixed immediate annuities with their model portfolios, while another might choose to include all products.

Referring back to FIG. 2, next in step 203 Monte Carlo simulations on the combined investor factors and product combinations are performed. To perform the Monte Carlo simulations in this embodiment, the method substitutes a range of values for factors with inherent uncertainty to calculate the results. Results are calculated multiple times using different sets of random values from the Monte Carlo simulation model. The Monte Carlo simulations produce distributions of possible values (e.g., account balances and death benefit, etc.) based on the different asset and product allocations.

FIG. 3 provides an embodiment for creating the solution space described in FIG. 2. Each of the asset and product allocation combinations is combined with investor(s)' age(s), desired withdrawal rates, and Monte Carlo simulations to create the solution space. A graphical representation of an example analyzing possible allocation between model portfolios, a deferred variable annuity with guaranteed lifetime withdrawal benefit and a fixed immediate annuity is shown by element 301 in FIG. 3. The embodiment in FIG. 3 shows how the solution space is created for one particular financial intermediary distributing investment products. In FIG. 3, the solution space is created by starting at element 302 and selecting age 50, then at element 303 a 0.5% withdrawal rate is chosen, then at element 305 a 100% investment in model portfolio one is selected. This combination is then applied to Monte Carlo scenario 1, shown in element 306. The model then performs the model calculation, element 307, and projects the annual liquid asset values, legacy values and other variables for that combination of factors, and stores the results in a solution space database. The projections are stored in solution space database 308. The solution space database can be a table, a relational database, or any other type of database known in the art. After projecting scenario 1, the model repeats the same calculations for Monte Carlo scenarios 2 through 500. The number of Monte Carlo scenarios can vary. At this point, one set of the 500 Monte Carlo scenarios has been completed. The process repeats for the same age (50 years old) and withdrawal percentage (0.5%), but this time the percentage of the investment in model portfolio is changed to 98% and the investment in the fixed immediate annuity is changed to 2%. For each model portfolio in this embodiment, the method will perform 500 Monte Carlo simulations for each asset and product combination and perform model calculation 307 and store the results in solution space 308.

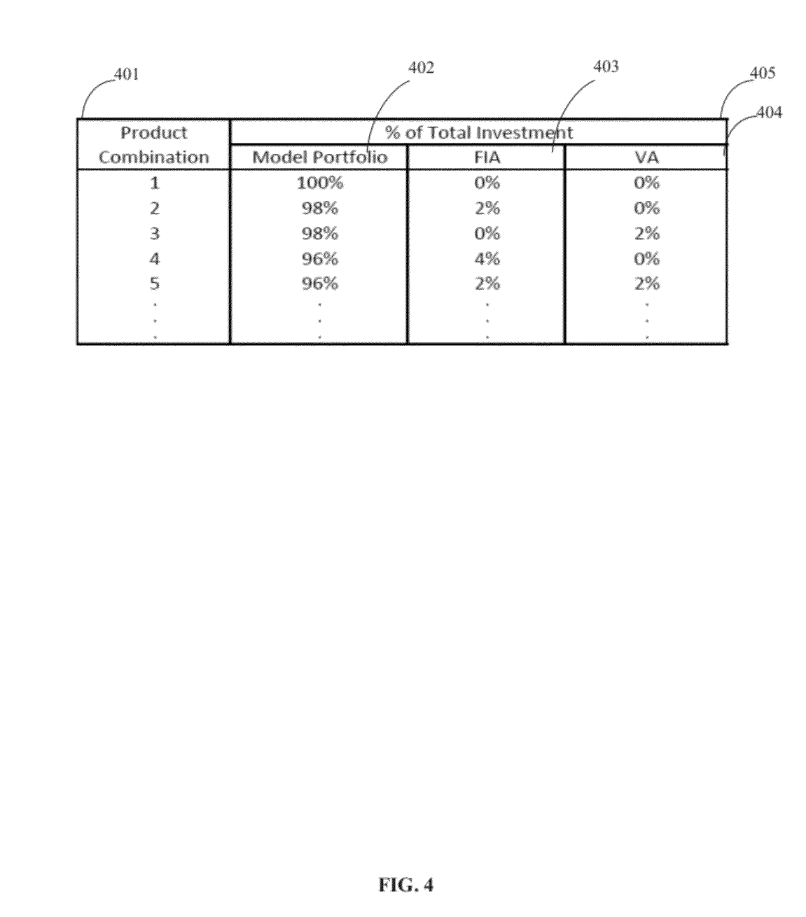

After 500 scenarios are completed for the second time by analyzing the second asset and product combination in element 305, the model calculates the next asset and product combinations and continues until the end of the asset and product combination permutations. FIG. 4 shows an embodiment of the different asset and product combinations that are possible. In the embodiment in FIG. 4, each asset and product combination, element 401, includes allocations of model portfolio 402, fixed immediate annuity (“FIA”) 403, and variable annuity with guaranteed lifetime withdrawal benefit (“VA”) 404. The percentage of total investment, 405, equals 100 percent for each asset and product combination 401.

Referring back to the embodiment in FIG. 3, at the end of the first investor permutation (age 50 and 0.5% withdrawal) with model portfolio one, 500 Monte Carlo simulations times 231 product combinations, which equals 115,500 runs have been completed. The process repeats for model portfolio two, shown in element 304, and continues until the last model portfolio has been analyzed. If the financial intermediary has five model portfolios, then 500 Monte Carlo simulations times 231 product combinations times the 5 model portfolios, which totals 577,500 runs will have been completed. The process continues until all 20 withdrawal rates, 0.5% to 10% in 0.5% increments, have been calculated, equaling 500×231×5×20=11,550,000 runs. At this point all the runs for age 50 have been completed, and analysis will repeat until all the ages have been analyzed, totaling around 500×231×5×20×7 which equals about 80 million runs to create the solution space (element 308) for this embodiment. One skilled in the art will appreciate that including more products, more model portfolios, smaller incremental increases in withdrawal rates, more ages, additional investor factors, or more Monte Carlo scenarios in the solution space, increases the number of runs.

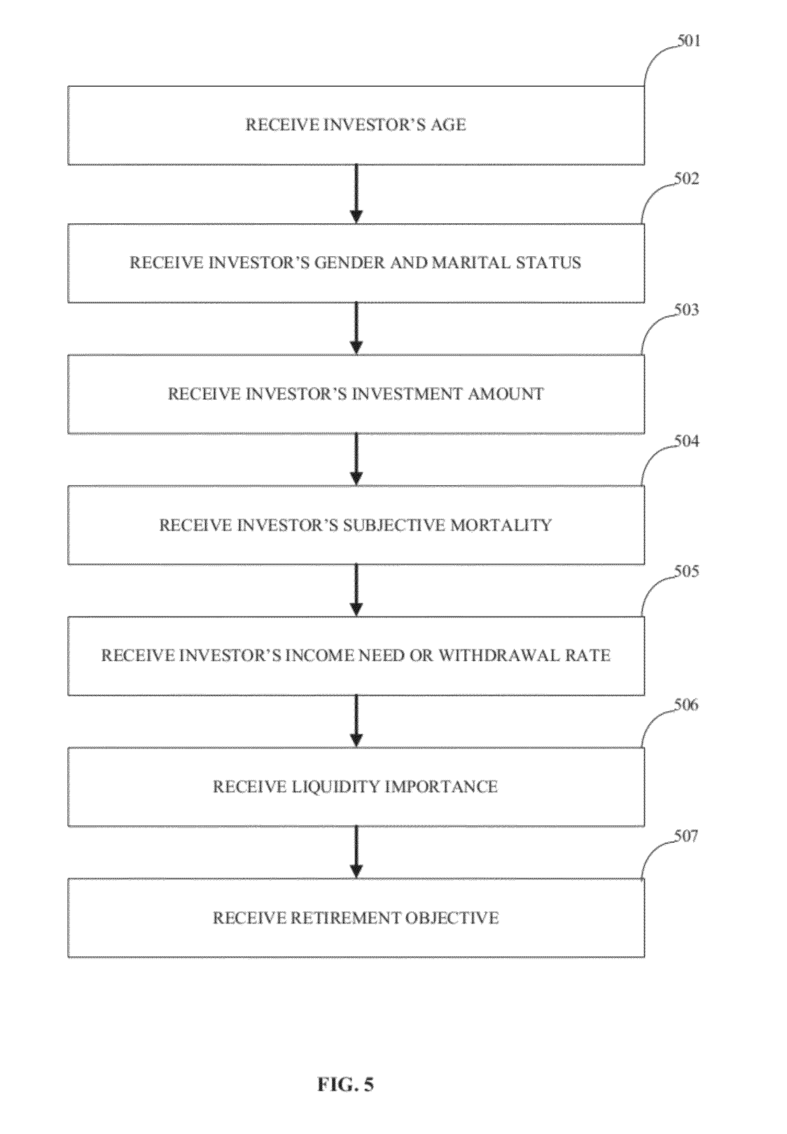

Referring back to the embodiment depicted in FIG. 1, the next step, 102, is receiving investor-specific information. This step is further illustrated by the embodiment in FIG. 5, showing possible steps for surveying the investor(s) to gather investor-specific information. First the investor(s)' age(s) is received at step 501; next in step 502 the investor(s)' gender(s), and if the investor is a joint participant, such as a married couple, the marital status of the couple is received. Next in step 503, the investment amount is received. In step 504 subjective mortality of the investor is received. The subjective mortality reflects the investor(s)' belief as to how long the investor will live; in the case of a joint investor, each investor can be individually polled and the combined subjective mortality can be calculated. Next in step 505 the investor(s)' income need or desired withdrawal rate is received. The desired withdrawal rate is applied to the initial investment amount. In this embodiment, the withdrawal amount requested by the investor(s) would increase with inflation. The income need or desired withdrawal rate reflects the amount of income that the particular investor(s) will need, which can be based on the investor(s)' lifestyle, among other factors. The investor(s) is also polled regarding the importance of liquidity in the early retirement years, step 506. In step 507 a selection by the investor(s) from among a range of retirement objectives is received. The retirement objectives reflect the desires of an investor(s) between a range of choices, such as whether the investor(s) seeks income security, liquidity potential, or legacy potential. An income security reflects, for example, the relative stability of cash flows during the life of the investment. A liquidity potential reflects, for example, the ability to relatively quickly access funds in the case of an emergency or other desires by the investor(s). A legacy potential reflects, for example, the desire of an investor(s) to leave assets to heirs after death. If the investor(s) has high liquidity needs, as indicated by the investor(s) in step 506, the retirement objectives presented in step 507 will range from maximum income security to maximum liquidity potential. On the other hand, if the investor(s) has low liquidity needs, the retirement objectives presented in step 507 will range from maximum income security to maximum legacy potential. Additionally, an inflation assumption, not shown, can also be defined by the financial intermediary. The information gathered in the client survey serves as a basis for searching the solution space in step 103 of FIG. 1.

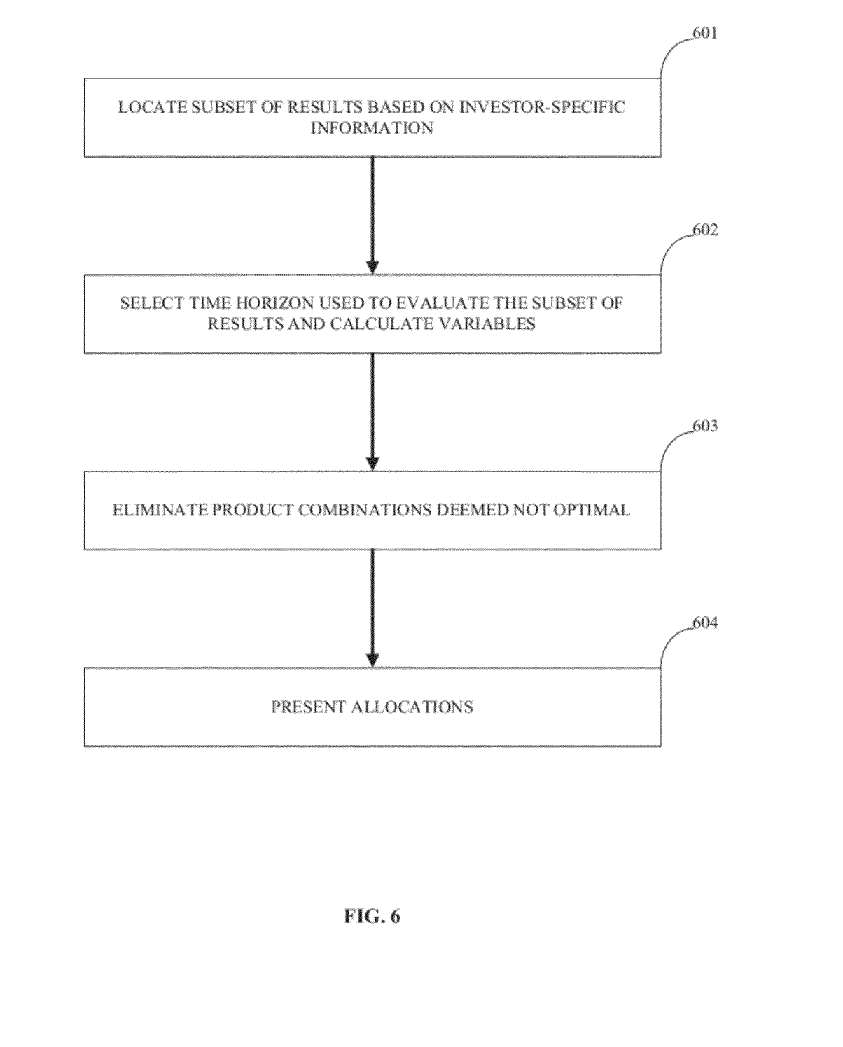

The third step in the embodiment shown in FIG. 1 is searching the solution space, element 103, to determine which optimal asset and product combination the investor(s) should select, based on the investor-specific information gathered previously. A further embodiment for searching the solution space in step 103 is shown in the flow chart of FIG. 6.

In step 601 of the embodiment shown in FIG. 6 the subset of results based on investor-specific information gathered previously is located. For a defined age(s), gender(s), marital status, subjective life expectancy(s), desired withdrawal rate, and liquidity importance in early retirement years, a graphical representation of optimal asset and product combinations can be created. For example, two frontiers that contain all optimal allocations can be created. Then, depending on the investor(s)' liquidity importance in early retirement years (high or low), one of the two frontier lines is used to optimally determine the asset and product allocation. For example, if the investor is a 65-year-old single male and would like to invest $1M with an annual withdrawal of $40,000, the subset of results for a person at age 65 and a 4% withdrawal rate are located. Continuing with the example where a financial intermediary chooses to include a deferred variable annuity with a guaranteed lifetime withdrawal benefit and a fixed immediate annuity with their five model portfolios, the subset of results will have 5×231=1,155 sets of Monte Carlo projections. Next, in step 602, based on the gender and subjective life expectancy questions, the time horizons used to evaluate the 1,155 product combinations are selected. After selecting the time horizons, three variables are calculated in step 602. For each set of Monte Carlo projections, the three variable calculated are: (1) a statistical measurement of the legacy benefit at a subjective life expectancy; (2) a statistical measurement of the liquid asset value determined at a time horizon that is prior to the subjective life expectancy, and (3) the probability of ruin at a time horizon beyond the subjective life expectancy. Through these three variables, either the legacy benefit variable or the liquid asset value variable is used, depending on the relative importance of liquidity in the early years. For example, if the statistical measurement chosen is the 50^{th} percentile, and if the liquidity preference is low (i.e., legacy benefit variable is used, liquid asset value variable is not used) an asset and product combination having a 50^{th} percentile legacy benefit of $100,000 and a probability of ruin of 2% is more optimal than an asset and product combination having a 50^{th} percentile legacy benefit of $85,000 and the same probability of ruin. Then, in step 603, asset and product combinations that are not optimal can be eliminated, such as the asset and product combination having a 50^{th} percentile legacy benefit of $85,000 and a probability of ruin of 2%.

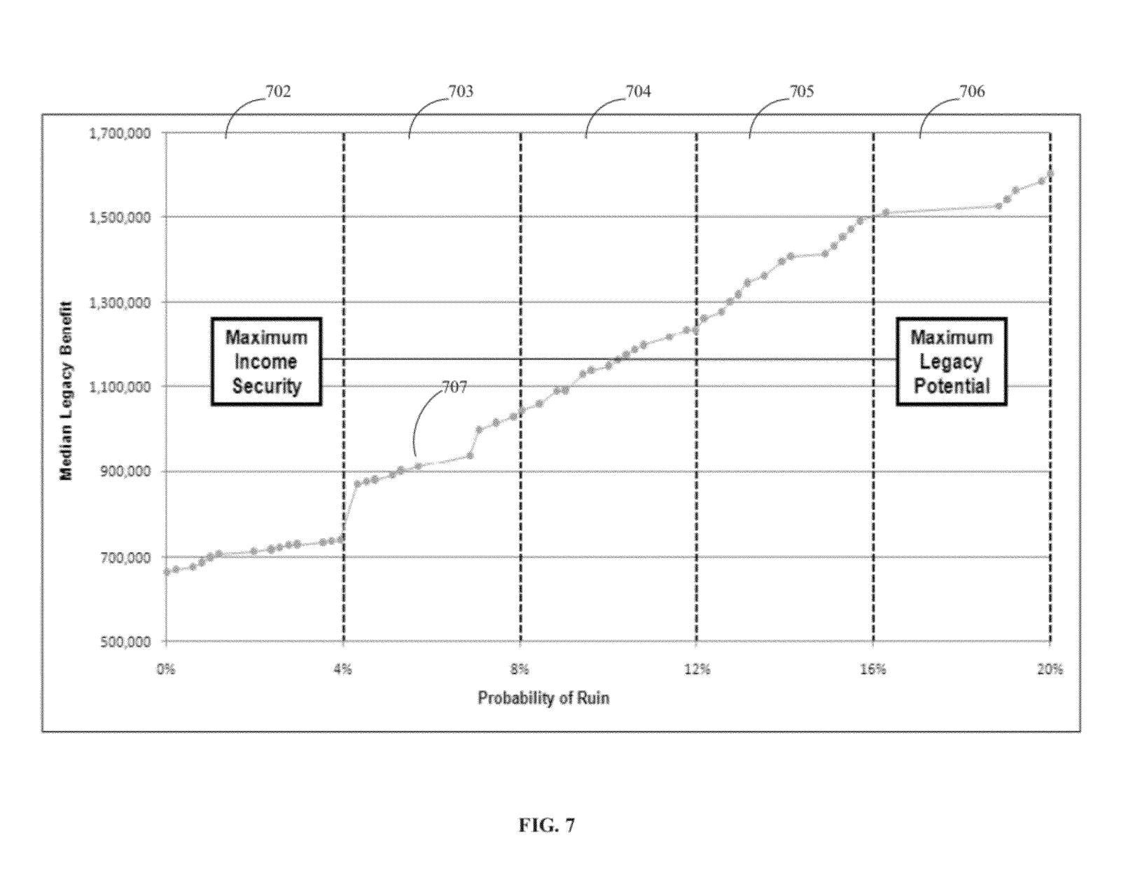

Based on the asset and product combinations that are not eliminated in step 603, an appropriate frontier line can be created, as shown by the example in FIG. 7. FIG. 7 assumes that there are five retirement objectives and that the investor(s) has low liquidity needs. Further, FIG. 7 shows retirement objective partitions 702 through 706, and a graph of the optimal asset and product allocations, one of which is represented by element 707. The frontier represented by the line graph in FIG. 7 is partitioned into five sections (elements 702-707), one section for each retirement objective. The optimal product and asset combinations that result in the lowest probability of ruin, represented by partition 702, are suitable for investors who want Maximum Income Security. The product and asset combinations that result in the highest legacy benefits are suitable for investors who want Maximum Legacy Potential, represented by partition 706. If the investor has high liquidity needs, a similar graph can be created with the vertical axis showing liquid asset values. The last partition of such graph will be suitable for one who wants Maximum Liquidity Potential.

In a more specific example, given an age of an investor, a subjective life expectancy, a withdrawal rate, and low liquidity importance in the early retirement years, the legacy benefit and probability of ruin can be graphed. Again, in this example, the statistical measurement of 50^{th} percentile is used. Each dot on the graph, one of which is shown as element 707 in FIG. 7, represents an optimal product and asset combination for a sixty-five-year-old single male with an average subjective life expectancy, an initial 4% withdrawal rate and low liquidity needs in the early retirement years. Each dot 707 represents an optimal product and asset combination, that is, the combination that produces the highest median legacy benefit for a given probability of ruin. The five partitions 702-707, ranging from Maximum Income Security to Maximum Legacy Potential, are separated by the dotted lines and are evenly split among the probability of ruin. Each of these five partitions corresponds to the five retirement objectives received in step 102 of FIG. 1.

Referring back to FIG. 7, within each of the five partitions 702-706, the asset and product combination that produces the highest statistical ratio, such as a legacy-to-ruin ratio, is selected. In one embodiment, in each of the five partitions 702-706, an asset and product combination that produces the highest legacy-to-ruin ratio is selected. One form of this expression is:

$$\frac{{Legacy}_{50 th Percentile}}{Investment} \times \frac{1}{Ψ}$$

$$Where$$

$$\frac{{Legacy}_{50 th Percentile}}{Investment}$$

represents a statistical measurement of legacy benefit and Ψ represents a statistical distribution of risk for a given asset and product combination.

In another embodiment, the highest liquidity-to-ruin ratio is used if the investor(s) has high liquidity needs in the early retirement years. Thus, one asset and product combination for each retirement objective for a given age(s), gender(s), marital status, subjective life expectancy(s), liquidity importance, and income need can be recommended.

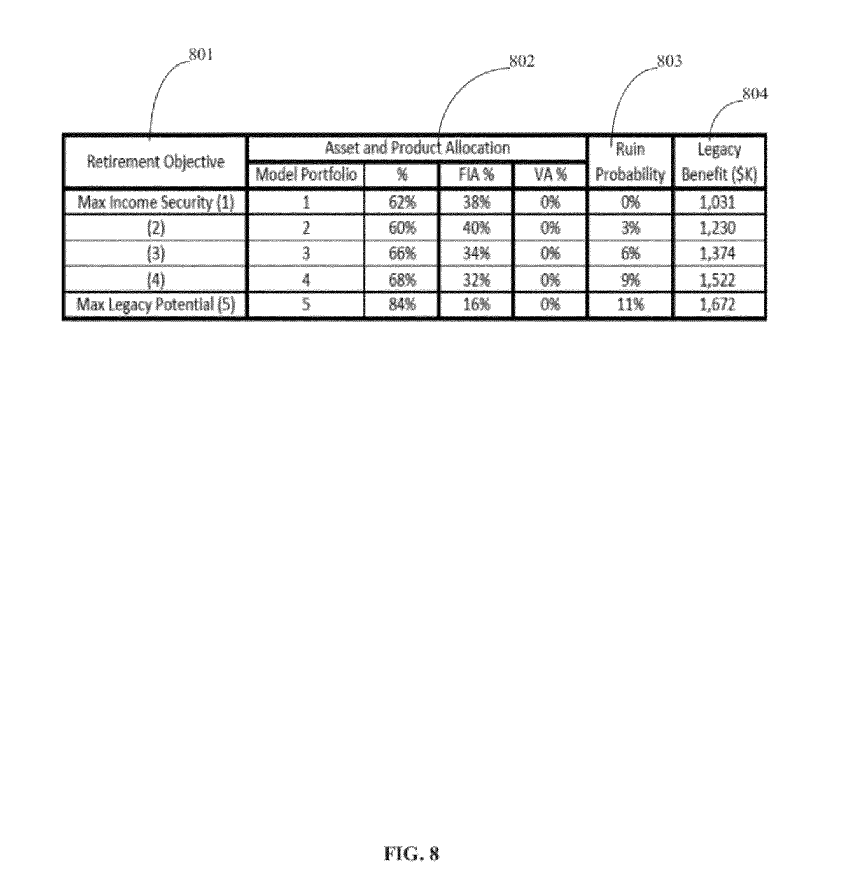

FIG. 8 depicts an example of optimal asset and product combinations for a specific investor with low liquidity needs. FIG. 8 includes representations for the investor's retirement objective 801, asset and product allocation 802, ruin probability 803, and the chosen statistical measurement of legacy benefit 804. Accordingly, based on the investor's retirement objective 801 this example shows the portfolio allocations associated with five retirement objectives, spanning from “maximum income security” to “maximum legacy potential.” If the investor chooses “maximum income security,” then 62% of assets allocated to the model portfolio one, 38% of assets allocated to the fixed immediate annuity, and 0% of the assets allocated to the variable annuity are recommended. The ruin probability for such an allocation of assets and products and the legacy benefit can also be presented.

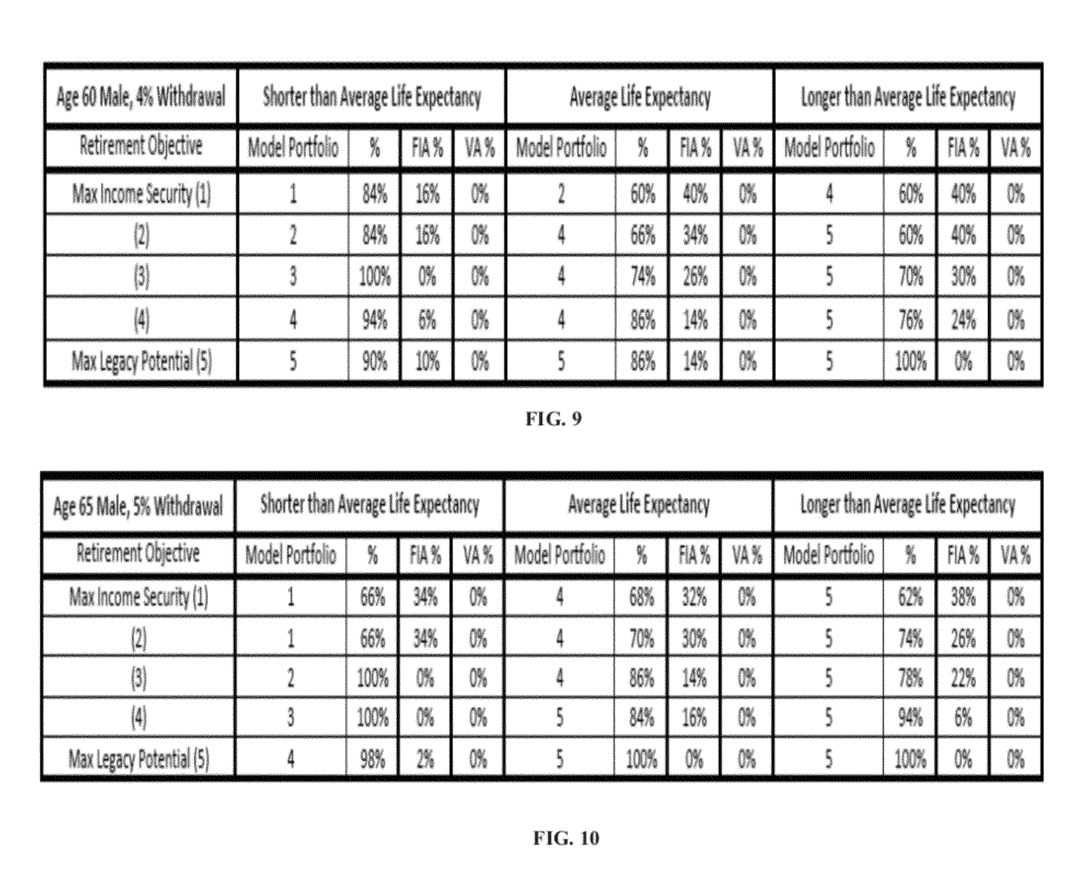

Additional examples of product and asset allocations for investor-specific factors are shown below, in FIGS. 9 and 10. FIG. 9 presents examples of optimal allocations for a male investor, age 60 with a 4% withdrawal rate. FIG. 10 presents examples of optimal allocations for a male investor, age 65 with a 5% withdrawal rate.

In FIG. 8, based on the investor's retirement objective, one combination from among the five presented is selected. The selected combination represents the optimal product and asset allocation while considering the investor's age, gender, marital status, subjective life expectancy, income need, liquidity importance, and retirement objective. This selected portfolio can then be presented to the investor in step 104 of FIG. 1.

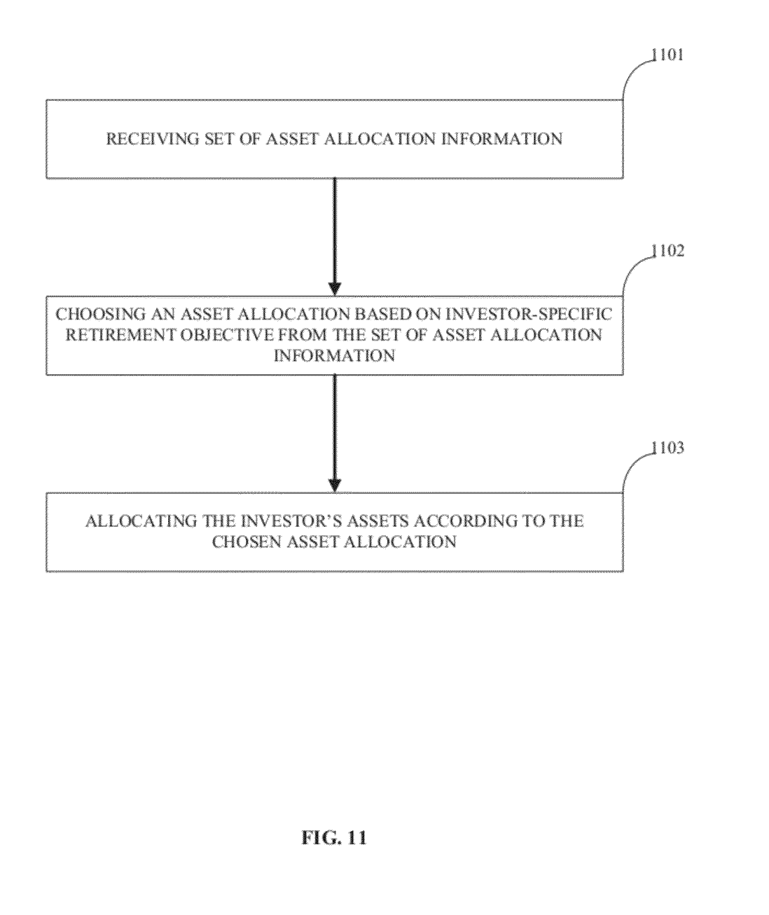

FIG. 11 illustrates a flowchart of the steps for one embodiment for allocating assets and products as indicated by step 104 in FIG. 1. In step 1101 a set of asset and product allocation information is received. The asset and product allocation information may be calculated by any of the embodiments contained in FIGS. 1-10. Next, in step 1102 an asset and product allocation based on the investor-specific retirement objective is chosen from the set of asset and product allocation information. Finally, in step 1103 the investor(s)' funds are allocated according to the chosen allocation from step 1102.

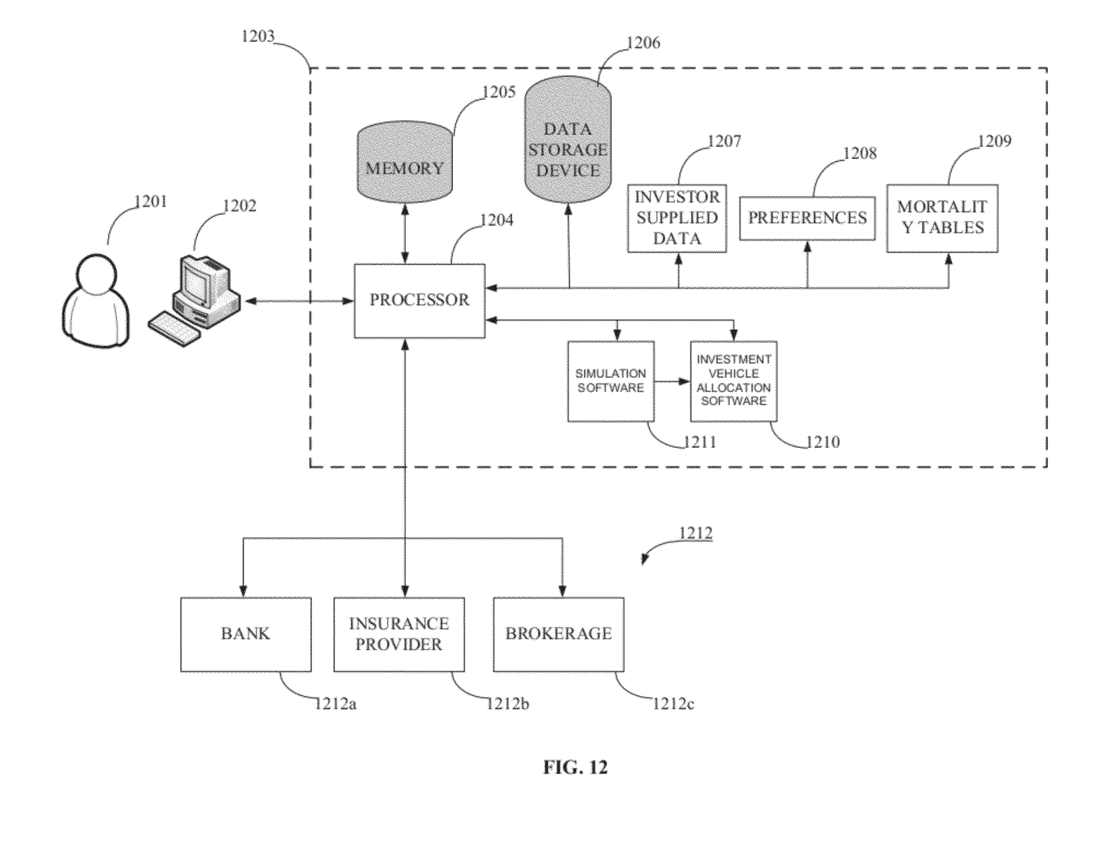

FIG. 12 illustrates an embodiment that provides for the allocation of assets and products as described above. The asset and product allocation, in this embodiment, is provided through a computer program product including executable instructions stored on a computer readable medium. By way of example, a processor 1204 performs executable operations based on instructions received from the memory device 1205. Through the operations, the processor 1204 administers and tracks the asset and product allocation in a variety of ways. For example, the processor may be used for managing the investment vehicles, receiving investor-specific information, performing asset and product allocation computations and allocating an investor(s)' portfolio. The investor(s)' portfolio of assets and products may be accessed and allocated via financial institutions 1211 connected to processor 1204.

As illustrated in FIG. 12, the user 1201 may be an investor operative to access the investment portfolio allocation system 1203, via computer 1202, as generated and run on processor 1204. The processor 1204 is operative to perform the computing operations described above. The system 1203 includes the processor 1204, memory device 1205, data storage device 1206, investor supplied data 1207, preferences 1208, mortality tables 1209, investment vehicle allocation software 1210, and simulation software 1211. It is also understood that system 1203 and related components, 1204-1211 may be disposed directly within the computer 1202, or may be distributed throughout a network.

Processor 1204 produces an asset and product allocation solution space by executing simulation software 1211 to simulate the investment vehicle allocations constructed by the investment vehicle allocation software 1210 and configured to communicate with investment vehicle allocation software 1210. Based on investor(s) supplied data 1207, preferences 1208, and mortality tables 1209, the processor 1204 calculates an allocation of assets and products.

Financial institutions 1212, which may include bank 1212a, insurance provider 1212b, and brokerage 1212c serve to process the asset and product allocation recommendations calculated by the system 1203. After calculating the recommended asset and product allocations, processor 1204 transmits data to each of the financial institutions 1212 with instructions to purchase specified amounts of the allocated assets and products. For example, insurance provider 1211b is instructed to purchase a certain amount of annuities for the investor, and brokerage 1211c is instructed to purchase a certain amount of common stock for the investor.

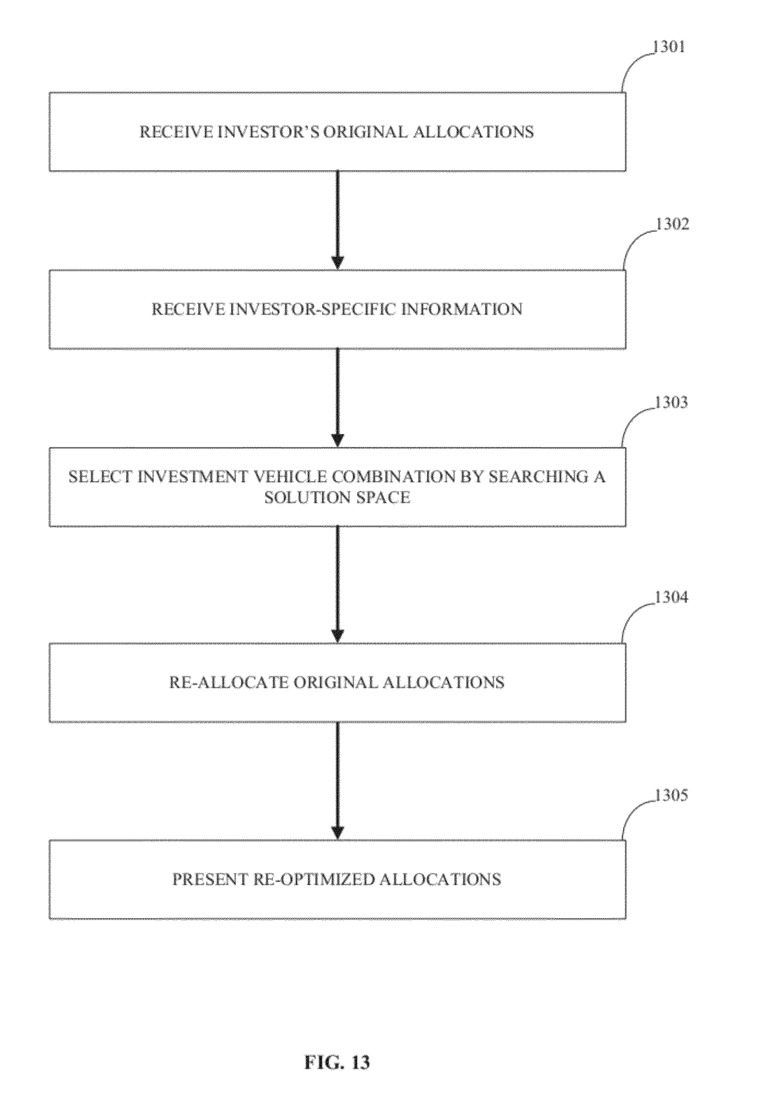

FIG. 13 illustrates a flowchart for one embodiment to re-optimize an allocation of assets and products among a plurality of financial products. Re-optimization, in some embodiments, differs from an allocation of assets among a plurality of financial products because an investor seeking re-optimization of a portfolio may hold both assets and products in a portfolio. Therefore, re-optimization is discussed in terms of allocations among assets and products. In step 1301 the investor's original asset and product allocations are received. In one embodiment the received asset and product allocations were calculated by using the embodiment illustrated in FIG. 1. In another embodiment the received asset and product allocations were calculated using another allocation system or method. Next, in step 1302, the investor-specific information, such as that described with respect to FIG. 5, is received. Next, in step 1303, the solution space is searched to determine an allocation of assets and products based on the investor-specific information. In one embodiment the solution space is calculated and searched using the steps outlined in FIG. 1. Next, in step 1304, the investor(s)' original asset and product allocations are re-allocated based on the information gathered in the previous steps, and in step 1305 the re-optimized asset and product allocation among a plurality of financial products is presented to the investor(s). The re-optimized asset and product allocation accounts for the possibility that some financial products, such as a FIA, cannot or are difficult to liquidate. Therefore the investor's portfolio, which consists of stocks and fixed income products (e.g., bonds, FIA), is allocated in a manner to account for the non-liquid financial products.

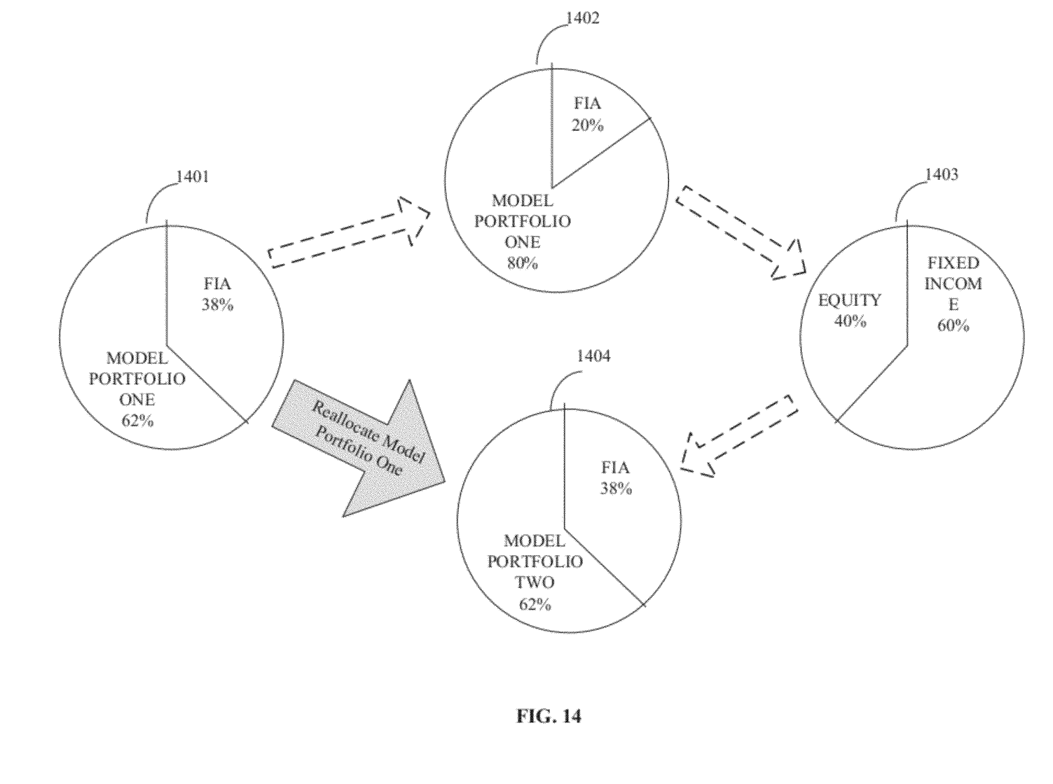

FIG. 14 shows one embodiment of the re-optimization steps described in FIG. 13 when an investor's portfolio should be re-optimized to reduce the amount allocated to fixed immediate annuities. Element 1401 depicts an investor's portfolio prior to re-optimization, which consists of 38% FIA and 62% model portfolio one. In this embodiment, model portfolio one further consists of 50% equities and 50% fixed income. Element 1402 depicts a new suggested allocation of financial products based on investor-specific information after undergoing allocation such as that depicted in FIG. 1. The new allocation recommends a higher allocation to model portfolio one and a lower allocation to FIA.

To re-optimize to the new recommendation, the model portfolio and FIA in element 1402 are broken down and represented by element 1403 as allocations of equities (40%) and fixed income (60%), where the fixed income allocation includes the FIA. Based on the equity and fixed income percentages in element 1403, the allocations can be adjusted by, in this example, substituting in a different model portfolio, as shown in element 1404. In element 1404, model portfolio one (consisting of 50% equities and 50% fixed income) is replaced with a model portfolio two, consisting of 65% equities and 35% fixed income. Including the FIA, the overall allocation is now 40% equities and 60% fixed income, which is equivalent to element 1403. Thus, the allocations in element 1404 have a similar profile as the suggested allocations in element 1402, while allowing the investor to maintain the 38% of the FIA.

FIGS. 1 through 14 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computerized method for allocating assets among a plurality of financial products for an investor portfolio, comprising:
calculating a solution space of financial vehicle combinations by assigning allocations to each financial vehicle in each financial vehicle combination and generating a set of simulations, for each of the vehicle combinations, of a value of the financial vehicle combination;
receiving investor-specific information, the investor-specific information including a retirement objective;
selecting a set of financial vehicle combinations within the solution space based on the received investor-specific information; and
allocating assets among the plurality of financial products based on the set of selected financial vehicle combinations and received investor-specific information.

2. The computerized method of claim 1, wherein calculating a solution space of financial vehicles further comprises calculating a solution space of financial vehicles selected from the set consisting of: model portfolios, deferred variable annuities inclusive of all commonly selected riders (e.g., guaranteed minimum accumulation benefit, guaranteed lifetime withdrawal benefit, guaranteed minimum withdrawal benefit, guaranteed minimum death benefit, guaranteed minimum income benefit), deferred fixed annuities, deferred income annuities, variable immediate annuities, and fixed immediate annuities inclusive of all commonly selected options/riders (e.g., inflation protection options such as cost of living adjustments and CPI-indexed payouts).

3. The computerized method of claim 1, wherein generating a set of simulations further comprises generating a set of Monte Carlo simulations.

4. The computerized method of claim 1, wherein the investor-specific information further includes at least one of: a gender, an age, marital status, a subjective life expectancy, an investment amount, and a desired withdrawal percentage.

5. The computerized method of claim 1, wherein the retirement objective includes an investor(s)' preference between income security, liquidity potential, and legacy potential.

6. The computerized method of claim 1, wherein selecting a set of financial vehicle combinations further comprises eliminating financial vehicle combinations within the selected set of financial vehicle combinations based on a reward-to-risk ratio.

7. The computerized method of claim 6, wherein the reward-to-risk ratio is based on a statistical measurement of legacy benefit at the subjective life expectancy or a statistical measurement of liquid asset value prior to the subjective life expectancy, and a probability of ruin beyond the subjective life expectancy.

8. The computerized method of claim 1, wherein the step of selecting a set of financial vehicle combinations within the solution space further comprises:
generating a frontier representation based on the selected set of financial vehicle combinations; and
partitioning the frontier representation based on the retirement objectives.

9. The computerized method of claim 8, wherein the step of partitioning the frontier representation comprises:
selecting a financial vehicle combination within each of the partitions of the frontier representation, the financial vehicle combination based on a reward-to-risk ratio; and
providing, as a recommendation to the investor(s), the selected financial vehicle combination.

10. The computerized method of claim 1 further comprising re-optimizing the allocation of assets among the plurality of financial products.

11. The computerized re-optimizing method of claim 8 further comprising:
selecting a financial vehicle combination by searching a solution space based on the received investor-specific information; and
re-allocating the original asset allocations by assigning allocations to each financial product based on the selected financial vehicle combination.

12. A computer program product for use in a computer system that executes program steps recorded on one or more computer readable media to perform a method for providing an allocation of assets among a plurality of financial products for an investor portfolio, the computer program product comprising:
one or more computer readable media;
one or more computer programs of computer readable instructions executable by the computer system to perform method steps comprising:
calculating a solution space of financial vehicle combinations by assigning allocations to each financial vehicle in each financial vehicle combination and generating a set of combination;
receiving investor-specific information, the investor-specific information including a retirement objective;
selecting a set of financial vehicle combinations within the solution space based on the received investor-specific information; and
allocating assets among the plurality of financial products based on the set of selected financial vehicle combinations and received investor-specific information.

13. The computer program product of claim 12, wherein calculating a solution space of financial vehicles further comprises calculating a solution space of financial vehicles selected from the set consisting of: model portfolios, deferred variable annuities inclusive of all commonly selected riders (e.g., guaranteed minimum accumulation benefit, guaranteed lifetime withdrawal benefit, guaranteed minimum withdrawal benefit, guaranteed minimum death benefit, guaranteed minimum income benefit), deferred fixed annuities, deferred income annuities, variable immediate annuities, and fixed immediate annuities inclusive of all commonly selected options/riders (e.g., inflation protection options such as cost of living adjustments and CPI-indexed payouts).

14. The computer program product of claim 12, wherein generating a set of simulations further comprises generating a set of Monte Carlo simulations.

15. The computer program product of claim 12, wherein selecting a set of financial vehicle combinations further comprises eliminating financial vehicle combinations within the selected set of financial vehicle combinations based on a reward-to-risk ratio.

16. The computer program product of claim 15, wherein the reward-to-risk ratio is based on a statistical measurement of legacy benefit at the subjective life expectancy or a statistical measurement of the liquid asset value prior to the subjective life expectancy, and a probability of ruin beyond the subjective life expectancy

17. The computer program product of claim 12, wherein the financial vehicle combinations within the solution space further comprises:
generating a frontier representation based on the selected set of financial vehicle combinations; and
partitioning the frontier representation based on the retirement objectives.

18. The computer program product of claim 17, wherein the step of partitioning the frontier representation comprises:
selecting a financial vehicle combination within each of the partitions of the frontier representation, the financial vehicle combination based on a reward-to-risk ratio; and
providing, as a recommendation to the investor, the selected financial vehicle combination.

19. The computer program product of claim 12, further comprising re-optimizing assets among the plurality of financial products.

20. A computerized system for providing an allocation of assets among a plurality of financial vehicles for an investor portfolio, comprising:
means for calculating a solution space of financial vehicle combinations by assigning allocations to each financial vehicle in each financial vehicle combination and generating a set of simulations, for each of the vehicle combinations, of a value of the financial vehicle combination;
means for receiving investor-specific information, the investor-specific information including a retirement objective;
means for selecting a set of financial vehicle combinations within the solution space based on the received investor-specific information; and
means for allocating assets among the plurality of financial vehicles based on the set of selected financial vehicle combinations and received investor-specific information.

21. A computerized method for re-optimizing an allocation of assets and products among a plurality of investment products for an investor portfolio, comprising;
receiving an original asset and product allocation for the investor portfolio;
receiving investor-specific information;
selecting a financial vehicle combination by searching a solution space based on the received investor-specific information; and
re-allocating the original asset and product allocation for the investor portfolio by assigning allocations to each financial product based on the selected financial vehicle combination.

22. The computerized method of claim 21, wherein re-allocating further comprises:
distinguishing between a liquid and a non-liquid financial product in the original asset and product allocation for the investor portfolio; and
adjusting the liquid financial product based on the selected financial vehicle combination.
